(19) United States
(12) Patent Application Publication
(10) Pub. No.: US 2026/0045596 A1
(43) Pub. Date: Feb. 12, 2026

(54) RECHARGEABLE ENERGY STORAGE SYSTEM HAVING SEPARATOR COATED WITH OXYGEN STORAGE CATALYST

(71) Applicant: GM GLOBAL TECHNOLOGY OPERATIONS LLC, Detroit, MI (US)

(72) Inventors: Mingjie Tu, Sterling Heights, MI (US); Vamakshi Yadav, Sterling Heights, MI (US); Jian Gao, Auburn Hills, MI (US); Hasnain Hafiz, Troy, MI (US)

(73) Assignee: GM GLOBAL TECHNOLOGY OPERATIONS LLC, Detroit, MI (US)

(21) Appl. No.: 18/795,258

(22) Filed: Aug. 6, 2024

(51) Int. Cl. H01M 12/08; H01M 4/02; H01M 4/58; H01M 50/403; H01M 50/417; H01M 50/451; H01M 50/46

(52) U.S. Cl. CPC H01M 12/08; H01M 4/5825; H01M 50/403; H01M 50/417; H01M 50/451; H01M 50/461; H01M 2004/028; H01M 2220/20

(57) ABSTRACT

A method for forming a battery cell in a rechargeable energy storage system includes providing a cathode and an anode, the cathode incorporating a lithium metal phosphate. The method includes positioning a separator between the cathode and the anode, the separator having an anode-facing side and a cathode-facing side. The method includes applying a catalyst layer composed of an oxygen storage catalyst on the cathode-facing side of the separator such that the catalyst layer continuously coats the cathode-facing side of the separator. The oxygen storage catalyst has an oxygen-capturing ability at or above a threshold temperature, the oxygen storage catalyst has an oxygen-retention ability at or above the threshold temperature and the threshold temperature is at least 200 degrees Celsius.

### INTRODUCTION

The present disclosure relates to a rechargeable energy storage system having a battery cell with a separator coated with an oxygen storage catalyst, as well as a corresponding method of forming the battery cell. The use of mobile platforms employing a rechargeable energy source, both as an exclusive source of energy and a non-exclusive source of energy, has greatly increased over the last few years. A rechargeable energy storage device with battery packs may store and release electrochemical energy as needed during a given operating mode. The electrochemical energy may be employed for propulsion, heating or cooling a cabin compartment, powering vehicle accessories and other uses. The various cells in the battery packs may be characterized by different power, state of charge and capacity rates. Many batteries employ a separator to prevent physical contact between the cathode and the anode, whilst promoting the movement of ions between them. The challenge with designing battery separators is the trade-off between mechanical robustness and porosity/transport properties.

### SUMMARY

Disclosed herein is a method for forming a battery cell in a rechargeable energy storage system. The method includes providing a cathode and an anode, with the cathode incorporating a lithium metal phosphate. The method includes positioning a separator between the cathode and the anode, the separator having an anode-facing side and a cathode-facing side. The method includes applying a catalyst layer composed of an oxygen storage catalyst on the cathode-facing side of the separator such that the catalyst layer continuously coats the cathode-facing side of the separator. The oxygen storage catalyst has an oxygen-capturing ability at or above a threshold temperature, the oxygen storage catalyst has an oxygen-retention ability at or above the threshold temperature and the threshold temperature is at least 200 degrees Celsius.

The method may include selecting the threshold temperature to be 250 degrees Celsius. The method may include configuring a thickness of the catalyst layer to be between 0.1 nanometers and 100 nanometers. The method may include incorporating a configuration [LiFeₓMn₁₋ₓPO₄] in the lithium metal phosphate of the cathode, where Li is lithium, Fe is iron, Mn is manganese, P is phosphorus and O is oxygen. The method may include selecting the oxygen storage catalyst to include a perovskite structure [ABO3], wherein A and B are cations and O is oxygen. The method may include selecting the oxygen storage catalyst to include ceric oxide [CeO2], wherein Ce is cerium and O is oxygen.

The method may include applying a binding layer between the cathode and catalyst layer, the binding layer being at least partially composed of polyvinylidene fluoride. The method may include applying the catalyst layer on the cathode-facing side of the separator using atomic layer deposition. The separator may be at least partially composed of polyethylene. The method may include applying the catalyst layer on the cathode-facing side of the separator using chemical vapor deposition.

Disclosed herein is a rechargeable energy storage system having one or more battery cells respectively having an anode and a cathode. The cathode incorporates a lithium metal phosphate. A separator is positioned between the anode and the cathode, the separator having an anode-facing side and a cathode-facing side. A catalyst layer continuously coats the cathode-facing side of the separator, the catalyst layer being composed of an oxygen storage catalyst. The oxygen storage catalyst has an oxygen-capturing ability at or above a threshold temperature, the threshold temperature being at least 200 degrees Celsius. The oxygen storage catalyst has an oxygen-retention ability at or above the threshold temperature.

Disclosed herein is a vehicle having a rechargeable energy storage system with one or more battery cells respectively having an anode and a cathode. The cathode incorporates a lithium metal phosphate. A separator is positioned between the anode and the cathode, the separator having an anode-facing side and a cathode-facing side. A catalyst layer continuously coats the cathode-facing side of the separator, the catalyst layer being composed of an oxygen storage catalyst, the catalyst layer having a thickness between 0.1 nanometers and 100 nanometers. A binding layer continuously coats the catalyst layer, the binding layer being between the cathode and the catalyst layer. The oxygen storage catalyst has an oxygen-capturing ability at or above a threshold temperature, and the threshold temperature is 250 degrees Celsius. The oxygen storage catalyst has an oxygen-retention ability at or above the threshold temperature.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic fragmentary diagram of a rechargeable energy storage system having a plurality of battery cells;

FIG. 2 is a schematic flow diagram of a method for forming the battery cells of FIG. 1; and

FIG. 3 is a schematic fragmentary diagram illustrating an alternative battery cell structure employable in the rechargeable energy storage system of FIG. 1.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

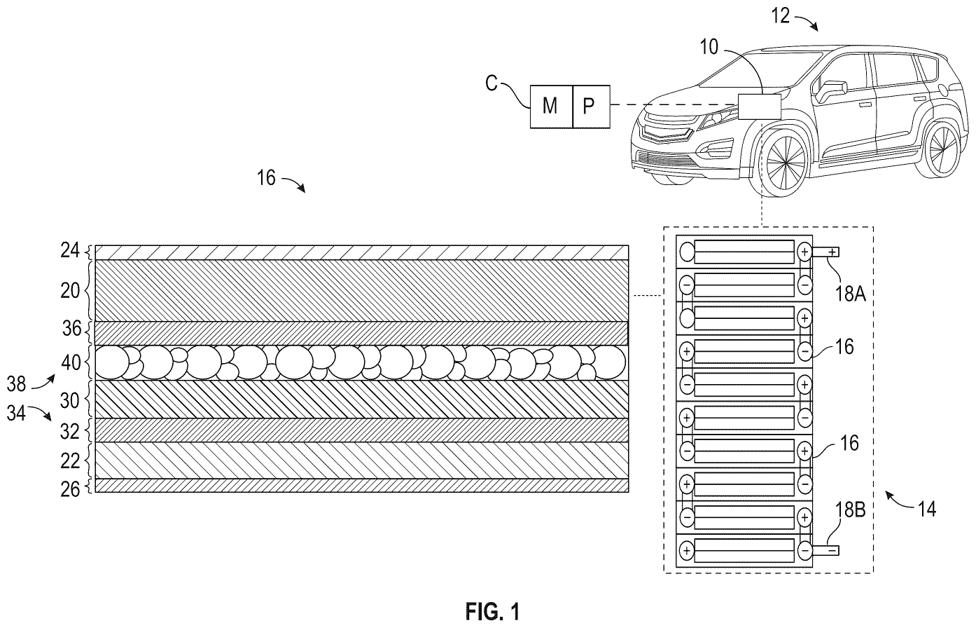

Referring to the drawings, wherein like reference numbers refer to like components, FIG. 1 schematically illustrates a rechargeable energy storage system 10 adapted to power a vehicle 12. The vehicle 12 may be partially electric or fully electric. The vehicle 12 may be a mobile platform, such as, but not limited to, a passenger vehicle, sport utility vehicle, light truck, heavy duty vehicle, ATV, minivan, bus, transit vehicle, bicycle, moving robot, farm implement (e.g., tractor), sports-related equipment (e.g., golf cart), boat, plane and train. It is to be understood that the vehicle 12 may take many different forms and have additional components.

The rechargeable energy storage system 10 includes at least one battery module 14 having a plurality of lithium-ion battery cells, such as battery cell 16 shown in FIG. 1, connected for current flow between a first terminal 18A and a second terminal 18B. It is understood that the number of battery modules in the rechargeable energy storage system 10 as well as the number of battery cells in each of the module may be varied based on the application at hand.

Referring to FIG. 1, an example structure for the battery cell 16 is illustrated. The battery cell 16 includes a cathode 20 and an anode 22, arranged between a first current collector 24 and a second current collector 26. A separator 30 is sandwiched between the cathode 20 and the anode 22. It is understood that the FIGS. presented herein are not drawn to scale. The separator 30 promotes the movement of ions from the cathode 20 to the anode 22 during charge and the reverse flow during discharge. The separator 30 is an isolator without electrical conductivity.

The separator 30 may be directly moistened with a first electrolyte layer 32 on an anode-facing side 34 of the separator 30, which is adjacent to the anode 22. Referring to FIG. 1, the separator 30 may be directly moistened with a second electrolyte layer 36 on the cathode-facing side 38, which is adjacent to the cathode 20.

The battery cells 16 may have different chemistries, including but not limited to, lithium-ion and lithium-iron phosphate (LFP) batteries. The battery cell 16 may incorporate a configuration [LiFexMn₁₋ₓPO₄] in the lithium metal phosphate of the cathode, where Li is lithium, Fe is iron, Mn is manganese, P is phosphorus and O is oxygen. Other materials available to those skilled in the art may be employed. The cathode 20 may be composed of lithium metal phosphates such as LiMPO4 [M: Fe, Mn, Co]. In some embodiments, lithium iron phosphate (LiFePO4) is used as the cathode material alongside a graphite carbon electrode with a metallic backing as the anode.

In lithium-iron phosphate (LFP) batteries, oxygen gas released from the cathode 20 may pass through the separator 30, causing side reactions at the anode 22 and triggering thermal runway. Thermal runaway propagation occurs when a single cell enters thermal runaway, releases a large quantity of heat, and heats neighboring cells to the point of thermal runaway. Thermal runaway in a battery cell 16 is generally detected after it happens. Additionally, the separator 30 may be prone to shrinkage at elevated temperatures.

The rechargeable energy storage system 10 acts as a mitigator to thermal runway events through strategic placement of oxygen trapping materials within battery cells. Additionally, the rechargeable energy storage system 10 improves the separator stability at elevated temperatures, as well as electrolyte wettability. The separator 30 is coated with an oxygen storage catalyst that increases both the thermal and mechanical stability (bi-functional) of the battery cell 16. As described below and referring to FIG. 1, the battery cell 16 includes a catalyst layer 40 continuously coating the cathode-facing side 38 of the separator 30, with the catalyst layer 40 being composed of an oxygen storage catalyst (OSC).

The oxygen storage catalyst is selected to have an oxygen-capturing ability at or above a threshold temperature, the threshold temperature being at least 200 degrees Celsius. In some embodiments, the threshold temperature is about 250 degrees Celsius. The oxygen storage catalyst is selected to have an oxygen-retention ability at or above the threshold temperature.

Referring to FIG. 1, the rechargeable energy storage system 10 may be operatively connected to a controller C with at least one processor P and at least one memory M (or non-transitory, tangible computer readable storage medium) on which instructions are recorded. The memory M may store controller-executable instruction sets, and the processor P may execute the controller-executable instruction sets stored in the memory M.

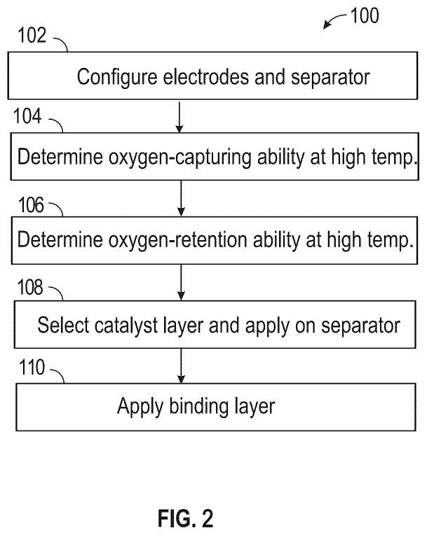

Referring now to FIG. 2, a flowchart of the method 100 for forming the battery cell 16 of FIG. 1 is shown. Method 100 may be embodied as computer-readable code or instructions stored on and partially executable by the controller C of FIG. 1. Method 100 need not be applied in the specific order recited herein. Furthermore, it is to be understood that some steps may be eliminated.

Per block 102 of FIG. 2, the method 100 includes providing a cathode 20 and an anode 22 and positioning a separator 30 between the cathode 20 and the anode 22. Advancing to block 104, the method 100 includes selecting a set of oxygen storage catalyst materials and screening the set for various parameters, such as adsorption abilities, availability, and other factors. Adsorption is the ability of solid materials to attract fluid molecules to their surface when in close proximity.

The method 100 includes screening the set of oxygen storage catalyst materials for their respective “oxygen-capturing ability” at or above a threshold temperature. The threshold temperature is at least 200 degrees Celsius. In some embodiments, the threshold temperature is about 250 degrees Celsius. In other words, if the oxygen storage catalyst material is unable to trap oxygen molecules at or above the threshold temperature, the oxygen storage catalyst material is deleted from the set. The screening may be executed using differential scanning calorimetry technique, in which the difference in the amount of heat required to increase the temperature of a sample and reference is measured as a function of temperature. Both the sample and reference are maintained at nearly the same temperature throughout the technique.

Proceeding to block 106, the method 100 includes screening the set of oxygen storage catalyst materials for their respective oxygen-retention ability at or above the threshold temperature. Stated differently, if the oxygen storage catalyst material is unable to retain the oxygen molecules at or above the threshold temperature, the oxygen storage catalyst material is deleted from the set. In some embodiments, the oxygen storage catalyst is selected to include a perovskite structure [ABO3], wherein A and B are cations and O is oxygen. Examples of such materials include LaxMO3 (M=Co, Mn and Ni; x=0.7-1.1), La(1−y) SryMO3 (M=Co, Mn and Ni; y=0−0.8), doped calcium manganite (CaBxMn1-xO3-δ, where B=Ti, Al, Sr), LaxSr1-xCoyM1-yO3-δ (M=Mn), and SCFC based oxygen sorbents (Sr1-xCaxFe1-yCoyO3-δ).

In some embodiments, the oxygen storage catalyst is selected to include ceric oxide [CeO2], wherein Ce is cerium and O is oxygen. Examples of such materials include pure CeO2, CeO2-ZrO2 solid solution, CeO2-MnO2, CeO2-CuO, CeO2-Fe2O3 solution, PGM (Pt, Pd and Rh) doped CeO2 based materials, and ceric oxide doped with other metals such as Sr, Pr, Sn, Tb, Ti.

Advancing to block 108, the method 100 includes applying the catalyst layer 40 on the cathode-facing side 38 of the separator 30 such that the catalyst layer 40 continuously coats the cathode-facing side 38 of the separator 30 with oxygen trapping materials. Application of the catalyst layer 40 may be executed using various methods, such as atomic layer deposition, where repetitive exposure with precursors causes successive deposition of layers. The catalyst layer 40 may be applied using spray drying, whereby an atomized liquid feed is applied as a fine spray, followed by contact with a stream of hot air to remove the solvent. The catalyst layer 40 may be applied through the deposition of chemical vapors.

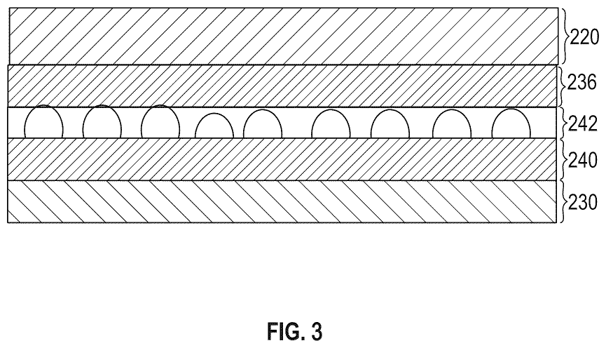

Proceeding to block 110, the method 100 includes applying a binding layer 242 adapted to improve adhesion of the catalyst layer 240 to the separator 230, an example of which is shown in FIG. 3. FIG. 3 is a schematic fragmentary diagram illustrating an alternative battery cell structure employable in the rechargeable energy storage system 10. The binding layer 242 may be at least partially composed of polyvinylidene fluoride. The binding layer 242 may be injected or molded into the cell structure, between the cathode 220 and the catalyst layer 240. Other methods available to those skilled in the art may be employed. The cell structure may include a second electrolyte layer 236 between the cathode 220 and the separator 230, as well as other components not shown.

In summary, the rechargeable energy storage system 10 provides avoidance and early mitigation of thermal runway situations. The separators 30, 230 having the catalyst layer 40, 240 respectively, leads to improved mechanical and thermal stability as well as improved electrolyte wettability. Computational methodology may be used to assess the mechanical stability and electrochemical properties of the separator 30, 230 with the coating materials, enabling the effective directional down selection of the most suitable materials.

The method 100 may be dynamically executed. As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

The controller C of FIG. 1 includes a computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, other magnetic medium, a CD-ROM, DVD, other optical medium, a physical medium with patterns of holes, a RAM, a PROM, an EPROM, a FLASH-EEPROM, other memory chip or cartridge, or other medium from which a computer can read.

Look-up tables, databases, data repositories or other data stores described herein may include various kinds of mechanisms for storing, accessing, and retrieving various kinds of data, including a hierarchical database, a set of files in a file system, an application database in a proprietary format, a relational database energy system (RDBMS), etc. Each such data store may be included within a computing device employing a computer operating system such as one of those mentioned above and may be accessed via a network in one or more of a variety of manners. A file system may be accessible from a computer operating system and may include files stored in various formats. An RDBMS may employ the Structured Query Language (SQL) in addition to a language for creating, storing, editing, and executing stored procedures, such as the PL/SQL language mentioned above.

The flowchart shown illustrates an architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by specific purpose hardware-based systems that perform the specified functions or acts, or combinations of specific purpose hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the function/act specified in the flowchart and/or block diagram blocks.

The numerical values of parameters (e.g., of quantities or conditions) in this specification, including the appended claims, are to be understood as being modified in each respective instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of each value and further divided ranges within the entire range. Each value within a range and the endpoints of a range are hereby disclosed as separate embodiments.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method for forming a battery cell in a rechargeable energy storage system, the method comprising:
providing a cathode and an anode, the cathode incorporating a lithium metal phosphate;
positioning a separator between the cathode and the anode, the separator having an anode-facing side and a cathode-facing side; and
applying a catalyst layer composed of an oxygen storage catalyst on the cathode-facing side of the separator such that the catalyst layer continuously coats the cathode-facing side of the separator, wherein the oxygen storage catalyst has an oxygen-capturing ability at or above a threshold temperature, the oxygen storage catalyst has an oxygen-retention ability at or above the threshold temperature and the threshold temperature is at least 200 degrees Celsius.

2. The method of claim 1, further comprising:
selecting the threshold temperature to be 250 degrees Celsius.

3. The method of claim 1, further comprising:
configuring a thickness of the catalyst layer to be between 0.1 nanometers and 100 nanometers.

4. The method of claim 1, further comprising:
incorporating a configuration [LiFeₓMn₁₋ₓPO₄] in the lithium metal phosphate of the cathode, where Li is lithium, Fe is iron, Mn is manganese, P is phosphorus and O is oxygen.

5. The method of claim 1, further comprising:
selecting the oxygen storage catalyst to include a perovskite structure [ABO3], wherein A and B are cations and O is oxygen.

6. The method of claim 5, further comprising:
selecting the oxygen storage catalyst to include ceric oxide [CeO2], wherein Ce is cerium and O is oxygen.

7. The method of claim 1, further comprising:
applying a binding layer between the cathode and catalyst layer, the binding layer being at least partially composed of polyvinylidene fluoride.

8. The method of claim 7, further comprising:
applying the catalyst layer on the cathode-facing side of the separator using atomic layer deposition, wherein the separator is at least partially composed of polyethylene.

9. The method of claim 7, further comprising:
applying the catalyst layer on the cathode-facing side of the separator using chemical vapor deposition, wherein the separator is at least partially composed of polyethylene.

10. A rechargeable energy storage system comprising:
one or more battery cells respectively having an anode and a cathode, the cathode incorporating a lithium metal phosphate;
a separator positioned between the anode and the cathode, the separator having an anode-facing side and a cathode-facing side;
a catalyst layer continuously coating the cathode-facing side of the separator, the catalyst layer being composed of an oxygen storage catalyst;
wherein the oxygen storage catalyst has an oxygen-capturing ability at or above a threshold temperature, the threshold temperature being at least 200 degrees Celsius; and
wherein the oxygen storage catalyst has an oxygen-retention ability at or above the threshold temperature.

11. The rechargeable energy storage system of claim 10, further comprising:
a binding layer continuously coating the catalyst layer, the binding layer being between the cathode and the catalyst layer, the binding layer being at least partially composed of polyvinylidene fluoride; and
wherein the catalyst layer has a thickness between 0.1 nanometers and 100 nanometers.

12. The rechargeable energy storage system of claim 10, wherein the lithium metal phosphate of the cathode has a configuration [LiFeₓMn₁₋ₓPO₄], where Li is lithium, Fe is iron, Mn is manganese, P is phosphorus and O is oxygen.

13. The rechargeable energy storage system of claim 12, wherein the catalyst layer incorporates a perovskite structure [ABO3] in the catalyst layer, where A and B are cations and O is oxygen.

14. The rechargeable energy storage system of claim 12, wherein the catalyst layer incorporates ceric oxide [CeO2], where Ce is cerium and O is oxygen.

15. A vehicle comprising:
a rechargeable energy storage system with one or more battery cells respectively having an anode and a cathode, the cathode incorporating a lithium metal phosphate;
a separator positioned between the anode and the cathode, the separator having an anode-facing side and a cathode-facing side;
a catalyst layer continuously coating the cathode-facing side of the separator, the catalyst layer being composed of an oxygen storage catalyst, the catalyst layer having a thickness between 0.1 nanometers and 100 nanometers;
a binding layer continuously coating the catalyst layer, the binding layer being between the cathode and the catalyst layer;
wherein the oxygen storage catalyst has an oxygen-capturing ability at or above a threshold temperature, and the threshold temperature is 250 degrees Celsius; and
wherein the oxygen storage catalyst has an oxygen-retention ability at or above the threshold temperature.

16. The vehicle of claim 15, wherein the binding layer is at least partially composed of polyvinylidene fluoride.

17. The vehicle of claim 16, wherein the separator is at least partially composed of polyethylene.

18. The vehicle of claim 15, wherein the lithium metal phosphate of the cathode has a configuration [LiFeₓMn₁₋ₓPO₄], where Li is lithium, Fe is iron, Mn is manganese, P is phosphorus and O is oxygen.

19. The vehicle of claim 18, wherein the catalyst layer incorporates a perovskite structure [ABO3] in the catalyst layer, where A and B are cations and O is oxygen.

20. The vehicle of claim 18, wherein the catalyst layer incorporates ceric oxide [CeO2], where Ce is cerium and O is oxygen.
